(19) United States
(12) Patent Application Publication
(10) Pub. No.: US 2010/0066926 A1
(43) Pub. Date: Mar. 18, 2010

(54) Image display apparatus and head-mounted display

(75) Inventor: Yasushi Tanijiri, Osaka (JP)

Correspondence Address: BRINKS HOFER GILSON & LIONE, P.O. BOX 10395, CHICAGO, IL, 60610, US

(73) Assignee: KONICA MINOLTA HOLDINGS, INC.

(21) Appl. No.: 12/586,007

(22) Filed: Sep. 15, 2009

(30) Foreign Application Priority Data
Sep. 17, 2008 (JP) 2008-237578

(51) Int. Cl. G02F 1/1335; G02F 1/13357

(52) U.S. Cl. 349/11; 349/62

(57) ABSTRACT

In a reflective LCD, a liquid crystal element has a back surface reflection light reducer. The back surface reflection light reducer may be a back surface reflection prevention coating provided on the air-side surface of a liquid crystal sealing base member as a second base member, or may be an inclined surface which is the air-side surface of the second base member inclined relative to the reflective surface of the LCD. When the back surface reflection light reducer is a back surface reflection prevention coating, the image light emerging from white-displaying pixels is hardly reflected on a back surface in the liquid crystal sealing base member, is extracted through the liquid crystal sealing base member to the air side, and is directed through an observation optical system to the optical pupil. Thus, even with a construction in which image light emerging in an oblique direction from the reflective surface of the reflective LCD is directed through an axis-asymmetric observation optical system to an observer's eye, it is possible to prevent a lowering in the contrast of the displayed image due to back surface reflection.

This application is based on Japanese Patent Application No. 2008-237578 filed on Sep. 17, 2008, the contents of which are hereby incorporated by reference.

### BACKGROUND OF THE INVENTION

1. Field of the Invention

The present invention relates to an image display apparatus that presents an image displayed on a display device to an observer in the form of a virtual image, and to a head-mounted display (hereinafter also referred to as an HMD) provided with such an image display apparatus.

2. Description of Related Art

Conventionally known image display apparatuses that let an observer observe an image displayed on a reflective display device (e.g., a reflective LCD) include, for example, those disclosed in JP-A-2001-343607 and JP-A-2003-107442. JP-A-2001-343607 discloses an image display apparatus in which the image light from a reflective LCD is directed through a projection optical system (e.g., a prism lens) to an observer's pupil to allow the observer to observe a virtual image of an image displayed on the reflective LCD.

In this image display apparatus, between the reflective LCD and the projection optical system, a light guide device (e.g., an illumination prism) is disposed. The light guide device and the reflective LCD are bonded together with adhesive. The adhesive here is one whose refractive index is substantially equal to those of the light guide device and of the cover glass of the reflective LCD. This construction, compared with a construction where no adhesive is used, reduces surface reflection at the interface between the light guide device and the cover glass, allowing high-contrast image display.

On the other hand, JP-A-2003-107442 discloses an image display apparatus of the type that lets an observer directly view an image displayed on a reflective LCD. In this image display apparatus, on the surface of the substrate of the reflective LCD, a transparent medium in the shape of saw teeth is disposed that has a predetermined refractive-index difference from the substrate; thus, when light is incident from a predetermined direction, the light reflected on the reflective electrode (i.e., the image light) is separated from the light reflected on the surface of the transparent medium, allowing the observer to observe a bright image.

Disadvantageously, however, an image display apparatus employing a reflective LCD suffers from a problem: back surface reflection occurring in the reflective LCD diminishes the contrast of the displayed image. Here, back surface reflection denotes the reflection of the light reflected from the reflective electrode that occurs at the interface between a liquid crystal sealing base member (cover glass) and a layer of air. This problem is more notable, than in image display apparatuses of the direct-view type, in a construction where the image light is emitted in a direction inclined relative to the direction perpendicular to the reflective electrode (reflective surface) of a reflective LCD and is directed to an observer's pupil via an axis-asymmetric observation optical system. This problem will now be discussed in detail.

FIG. 13 is a diagram schematically illustrating the optical path of the light incident on and emergent from a conventional reflective LCD. For example, when light L1 emitted from a light source and transmitted through a polarizer to become P-polarized light is incident on a white-displaying pixel 101a of a liquid crystal device 101 from an oblique direction and is converted into S-polarized light by the white-displaying pixel 101a, it then emerges, now as S-polarized light, in an oblique direction. When this light L1 undergoes back surface reflection in a liquid crystal sealing base member 111, it then falls, as back surface reflection light L1′, on another pixel 101b.

For example, if this pixel 101b is a black-displaying pixel, P-polarized light L2 that is regularly incident on the pixel 101b has its polarization left unchanged and emerges as P-polarized light; thus, it is then intercepted by an analyzer, achieving black display. Inconveniently, however, when back surface reflection light L1′, which is S-polarized light, is incident on the black-displaying pixel 101b, it too has its polarization left unchanged and emerges as S-polarized light; thus, it can then be transmitted through the analyzer, resulting in what should be completely black display being compromised with white display by an amount of S-polarized light commensurate with the back surface reflectance of the liquid crystal sealing base member 111. This causes a ghost to appear in black-displaying parts, and diminishes the contrast of the displayed image. Specifically, if the back surface reflectance is, for example, 5%, black-displaying parts suffer a ghost displayed with light intensity as high as 1/20 of white-displaying parts.

Incidentally, regular black-displaying light L2 (P-polarized) is absorbed by the analyzer at an absorptance of, for example, 99.9% or more, and therefore if the effect of the back surface reflection light L1′ mentioned above is disregarded, it is possible to display an image with very high contrast corresponding to the absorptance.

### SUMMARY OF THE INVENTION

The present invention has been made to solve the problems mentioned above, and it is an object of the invention to provide an image display apparatus that can prevent a lowering in the contrast of the displayed image due to back surface reflection even with a construction that employs a reflective LCD and in which back surface reflection greatly affects display quality (a construction in which image light reflected in an oblique direction from a reflective surface is directed to an observer's pupil via an axis-asymmetric observation optical system), and to provide a head-mounted display employing such an image display apparatus.

According to the invention, an image display apparatus is provided with: a light source; a reflective liquid crystal display device for displaying an image by modulating light from the light source; and an observation optical system that has an axis-asymmetric optical power and that directs, to an optical pupil, image light emerging in a direction inclined relative to the direction perpendicular to the reflective surface of the liquid crystal display device. Here, the liquid crystal display device is provided with: a liquid crystal element for modulating the light from the light source; a polarizer for transmitting, of the light emitted from the light source, light of a predetermined polarization direction so as to direct it to the liquid crystal element; and an analyzer for transmitting, of the light emerging from the liquid crystal element, light of a polarization direction perpendicular to the predetermined polarization direction so as to direct it to the observation optical system. Moreover, the liquid crystal element is provided with: a first base member that has a reflective electrode formed thereon so as to correspond to each pixel; a second base member that is transparent; liquid crystal that is held between the first and second base members; and a back surface reflection light reducer for reducing incidence, on the optical pupil, of light that is incident from the outer, air side via the second base member, that is then reflected on the reflective electrode, that is then reflected on a back surface in the second base member, and that then emerges via another reflective electrode to the air side.

### BRIEF DESCRIPTION OF THE DRAWINGS

This and other objects and features of the present invention will become clear from the following description of preferred embodiments with reference to the accompanying drawings:

FIG. 1 is a sectional view showing the detailed structure of a liquid crystal element applied to an image display apparatus embodying the invention;

FIG. 2 is a perspective view showing the construction of an HMD incorporating the image display apparatus;

FIG. 3 is a sectional view showing an outline of the construction of the image display apparatus;

FIG. 4 is a diagram illustrating the optical path of the image display apparatus on the ZX and YZ planes, with the optical path straightened;

FIG. 5 is a diagram illustrating the spectral intensity characteristic of the light source of the image display apparatus;

FIG. 6 is a diagram illustrating the wavelength dependence of diffraction efficiency in the hologram optical element of the image display apparatus;

FIG. 7 is a diagram illustrating the relationship between X-direction position and light intensity in the optical pupil of the image display apparatus;

FIG. 8 is a sectional view schematically showing another construction of the image display apparatus;

FIG. 9 is a sectional view showing the detailed structure of a liquid crystal element applied to the image display apparatus of FIG. 8;

FIG. 10 is a diagram illustrating the image display apparatus of FIG. 8, with its optical path straightened;

FIG. 11 is a sectional view schematically showing yet another construction of the image display apparatus;

FIG. 12 is a sectional view showing the detailed structure of a liquid crystal element applied to the image display apparatus of FIG. 11; and

FIG. 13 is a diagram schematically illustrating the optical path of light incident on and emergent from a conventional reflective LCD.

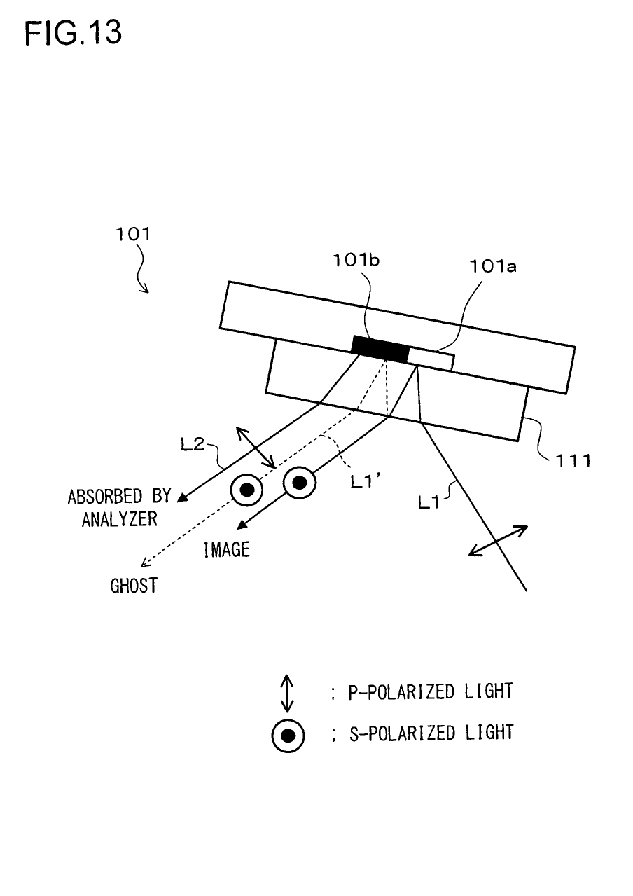

### DETAILED DESCRIPTION OF PREFERRED EMBODIMENTS

An embodiment of the present invention will be described below with reference to the accompanying drawings.

### 1. Construction of HMD

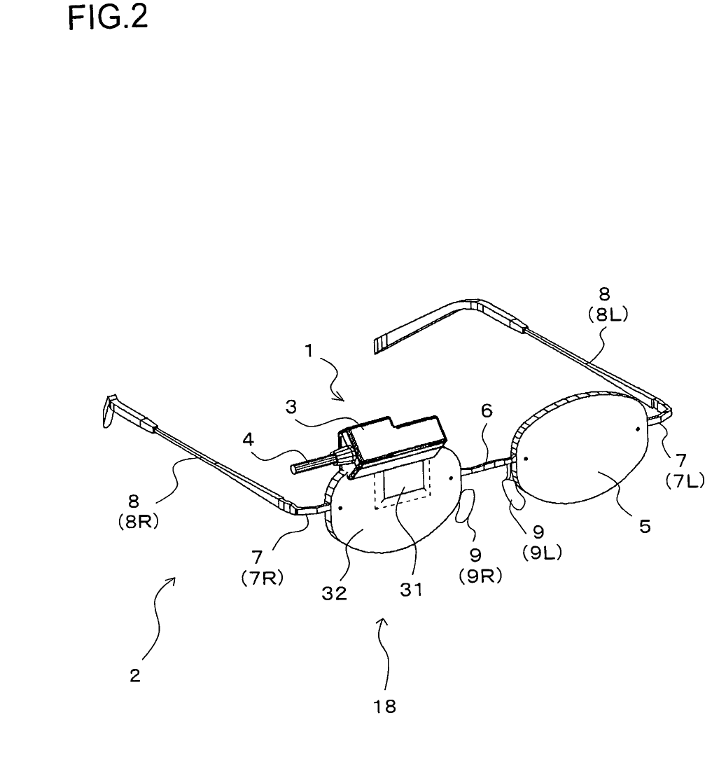

FIG. 2 is a perspective view showing an outline of the construction of an HMD of the embodiment. The HMD is composed of an image display apparatus 1 and a support mechanism 2.

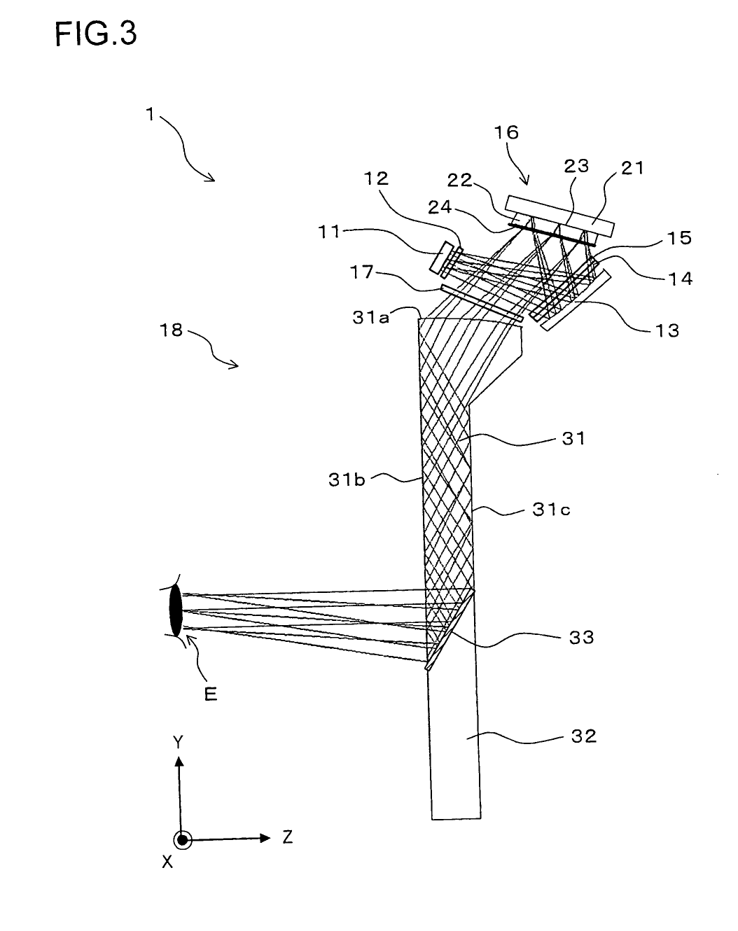

The image display apparatus 1 has a casing 3. The casing 3 houses at least a light source 11 and a liquid crystal element 16 (for both, see FIG. 3), and holds part of an observation optical system 18. The observation optical system 18 is composed of an eyepiece prism 31 and a deflecting prism 32 bonded together, which will be described later, and is as a whole shaped like one lens (in FIG. 2, the lens for the right eye) of eyeglasses. The light source 11 and the liquid crystal element 16 are fed with at least driving electric power and an image signal via a cable 4 provided through the casing 3.

The support mechanism 2 is a supporting means for supporting the image display apparatus 1 (in particular, the observation optical system 18) in front of one eye (e.g., the right eye) of an observer and supporting a dummy lens 5 in front of the other eye (e.g., the left eye) of the observer. More specifically, the support mechanism 2 is composed of the components enumerated below. Instead of providing the dummy lens 5, it is possible to provide two image display apparatuses 1 one for each eye and support them on the support mechanism 2.

The support mechanism 2 is composed of a bridge 6, frames 7, temples 8, and nose pads 9. The frames 7, the temples 8, and the nose pads 9 are provided in pairs, each pair including a left-hand one and a right-hand one, namely a right frame 7R, a left frame 7L, a right temple 8R, a left temple 8L, a right nose pad 9R, and a left noise pad 9L.

One end of the bridge 6 is coupled to the image display apparatus 1, and the other end of the bridge 6 is coupled to the dummy lens 5. The end of the image display apparatus 1 opposite from its end coupled to the bridge 6 is fixed to the right frame 7R. The right temple 8R is pivotally supported on the right frame 7R. On the other hand, the end of the dummy lens 5 opposite from its end coupled to the bridge 6 is fixed to the left frame 7L. The left temple 8L is pivotally supported on the left frame 7L.

When an observer uses the HMD, he wears it on his head as if wearing common eyeglasses, with the right temple 8R and the left temple 8L in contact with right and left side parts of the observer's head and the nose pads 9 put on his nose. In this state, when an image is displayed on the image display apparatus 1, the observer can observe, as a virtual image, the image displayed on the image display apparatus 1, and can simultaneously observe, on a see-through basis, an outside world image via the image display apparatus 1. The image display apparatus 1 will be described in detail below.

### 2. Construction of Image Display Apparatus

FIG. 3 is a sectional view showing an outline of the construction of the image display apparatus 1. The image display apparatus 1 has a light source 11, a polarizer plate 12, a mirror 13, a unidirectional diffuser plate 14, a polarizer 15, a liquid crystal element 16, an analyzer 17, and an observation optical system 18. The polarizer 15, the liquid crystal element 16, and the analyzer 17 together constitute a liquid crystal display device (LCD) that modulates the light from the light source 11 to display an image.

For the sake of convenience in the following description, different directions are defined as follow. The axis optically connecting between the screen center of the liquid crystal element 16 and the center of the optical pupil E formed by the observation optical system 18 is referred to as the optical axis. The direction along the optical axis when the optical path from the light source 11 to the optical pupil E is straightened is refereed to as the Z direction. The direction perpendicular to the optical axis incidence surface of a hologram optical element 33, which will be described later, provided in the observation optical system 18 is referred to as the X direction, and the direction perpendicular to the ZX plane is referred to as the Y direction. Here, the optical axis incidence surface of a hologram optical element denotes the plane including both the optical axis of the light incident on the hologram optical element 33 and the optical axis of the light reflected from the hologram optical element 33, that is, the YZ plane. In this embodiment, the observation optical system 18 is formed symmetrically about the plane including those optical axes, and therefore the optical axis incidence surface of the hologram optical element 33 is the plane of symmetry of the observation optical system 18.

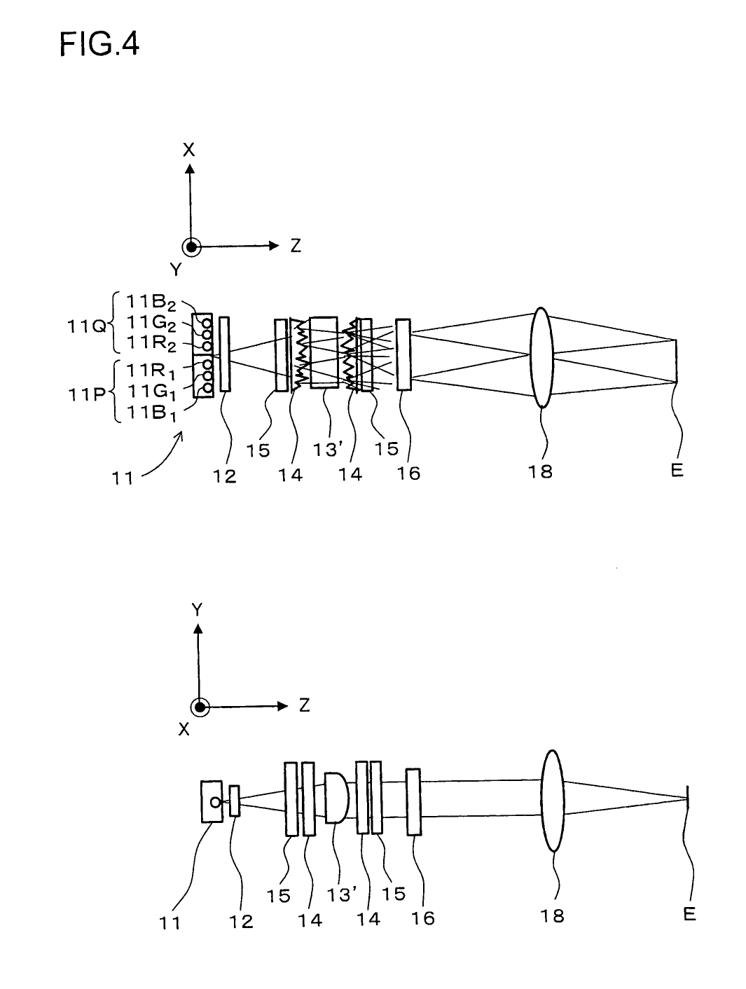

FIG. 4 is a diagram illustrating the optical path on the ZX and YZ planes, as it appears when straightened by replacing the mirror 13 with an optically equivalent lens 13′ (cylindrical lens) and by replacing the observation optical system 18 with a single lens. Since the unidirectional diffuser plate 14 hardly diffuses incident light in the Y direction as will be described later, in FIG. 4, the unidirectional diffuser plate 14 is shown as having no surface irregularities in the Y direction and having surface irregularities formed randomly in the X direction.

The light source 11 emits light toward the liquid crystal element 16, and is disposed on the observer (the optical pupil E) side of the optical path of the light traveling from the liquid crystal element 16 to the observation optical system 18. The light source 11 is composed of a plurality of light-emitting diodes (LEDs) emitting light of a plurality of different wavelengths. More specifically, as shown in FIG. 4, the light source 11 is composed of light source groups 11P and 11Q. The light source groups 11P and 11Q are each composed of an RGB composite LED (manufactured by Nichia Corporation) having light-emitting portions 11R₁, 11G₁, and 11B₁, or 11R₂, 11G₂, and 11B₂, emitting light corresponding to three primary colors, that is, light corresponding to R (red), G (green), and B (blue) respectively. The light source 11 may be one having the light source groups 11P and 11Q integrated into a single package.

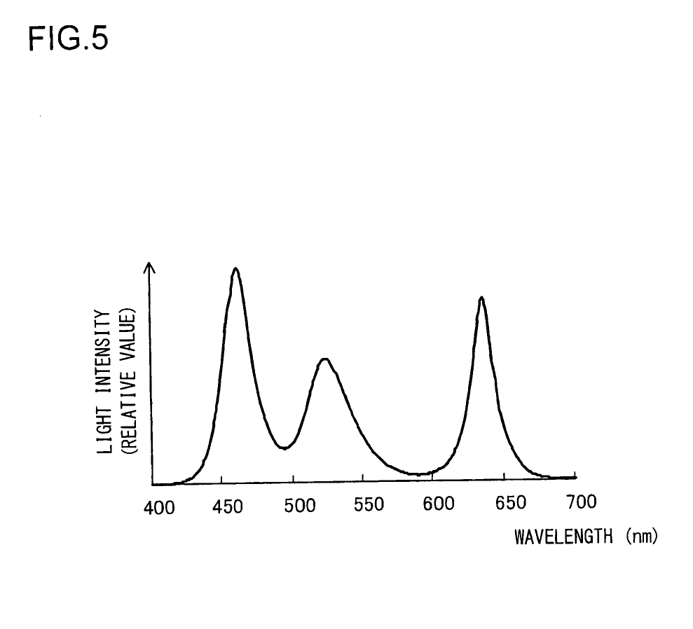

FIG. 5 is a diagram illustrating the spectral intensity characteristic of, that is, the relationship between the wavelength and intensity of the light emitted by, the light source 11. The light source 11 emits light in the wavelength ranges of, for example, 465±12 nm, 520±19 nm, and 635±10 nm as expressed in terms of the center wavelength and the light-intensity half-value wavelength width (full width at half maximum). In FIG. 5, light intensity is taken along the vertical axis and is given in values relative to the maximum intensity of B light taken as 100. The RGB light intensities of the light source 11 are adjusted with consideration given to the diffraction efficiency of the hologram optical element 33 and the light transmittance of the liquid crystal element 16, and this allows display of white. In this embodiment, as will be described later, a ferroelectric liquid crystal element that can be driven on a time-division basis is used as the liquid crystal element 16, and accordingly the light source 11 emits light corresponding to the three primary colors one after the next on a time-division basis.

The polarizer plate 12 shown in FIG. 3 is a polarizer plate that transmits light of the same polarization direction (e.g., P-polarized light) as the polarizer 15, which will be described later, but that intercepts light of the same polarization direction (e.g., S-polarized light) as the analyzer 17, which will be described later. Accordingly, of the light emitted from the light source 11, light that travels directly to the analyzer 17 and is transmitted by the analyzer 17, and light that is reflected on the surface of the polarizer 15 to travel to the analyzer 17 and is transmitted by the analyzer 17, can be cut beforehand with the polarizer plate 12. It is thus possible to prevent unnecessary light, not modulated by the liquid crystal element 16, from being transmitted through the analyzer 17 and directed to the optical pupil E.

The mirror 13 is a reflective member that reflects the light from the light source 11 toward the liquid crystal element 16, and is composed of a cylindrical mirror having such an optical power as to condense light only within the YZ plane. Since the mirror 13 has an optical power in this way, the light from the light source 11 can be condensed to illuminate the liquid crystal element 16, and thus the observer can observe a bright image; in addition, the optical path of the light traveling from the light source 11 to the liquid crystal element 16 can be bent with the mirror 13 to realize a compact, light apparatus. The mirror 13 may instead be composed of any other type of mirror such as a spherical-surface mirror, an a spherical-surface mirror, or an axis-asymmetric concave-surface mirror (free-form curved surface mirror).

In this embodiment, the mirror 13 is disposed on the side opposite from the light source 11 of the optical path of the light traveling from the liquid crystal element 16 to the observation optical system 18. That is, the mirror 13 is so disposed that the light source 11 and the mirror 13 are disposed across that optical path.

The unidirectional diffuser plate 14 diffuses the light emitted from the light source 11 in the X direction, that is, in the direction perpendicular to the plane of symmetry of the observation optical system 18, to direct it to the liquid crystal element 16. More specifically, the unidirectional diffuser plate 14 diffuses the incident light 40 degrees in the X direction and 0.5 degrees in the Y direction. Instead of the unidirectional diffuser plate 14, a common diffuser plate that diffuses light in both directions may be used.

The polarizer 15 transmits, of the light emitted from the light source 11, light of a predetermined polarization direction (here, P-polarized light) to direct it to the mirror 13, and transmits, of the light whose optical path has been bent by the mirror 13, light of the same polarization direction as the just mentioned predetermined polarization direction (here, P-polarized light) to direct it to the liquid crystal element 16. The analyzer 17 transmits, of the light emerging from the liquid crystal element 16, light of the polarization direction (here, S-polarized light) perpendicular to the above mentioned predetermined polarization direction to direct it to the observation optical system 18.

The liquid crystal element 16 is a reflective light-modulating device that has a plurality of pixels arrayed in a matrix and that modulates the light from the light source 11 on a pixel-by-pixel basis according to image data. More specifically, the liquid crystal element 16 has: a silicon substrate 21 (first base member) having reflective electrodes formed on it so as to correspond to individual pixels; a liquid crystal sealing base member (second base member) 22 that is composed of, for example, a cover glass and is transparent; liquid crystal 23 held between the silicon substrate 21 and the liquid crystal sealing base member 22; and a back surface reflection light reducer. Other than these, the liquid crystal element 16 further has opposing electrodes, an alignment coating, and a control circuit, of which none is illustrated. The back surface reflection light reducer will be described in detail later.

Other than the reflective electrodes mentioned above, the silicon substrate 21 has also formed on it wiring conductors such as scanning lines and signal lines and switching devices (e.g., TFTs) for turning the individual pixels on and off. The liquid crystal sealing base member 22 is the substrate on which the above-mentioned opposing electrodes are formed. The liquid crystal 23 modulates incident light by controlling the phase of its polarization, and is, in this embodiment, formed of ferroelectric liquid crystal.

The liquid crystal element 16 is arranged such that the longer-side and shorter-side directions of its rectangular display screen are aligned with the X and Y directions respectively. The liquid crystal element 16 has no color filters, and accordingly the individual pixels of the liquid crystal element 16 are turned on and off on a time-division basis in a manner corresponding to the light of the three primary colors fed from the light source 11 one color after the next on a time-division basis, so that, in each pixel, R, G, and B are displayed on a time-division basis. In this way, a color image can be presented to the observer. Moreover, since the liquid crystal element 16 has no color filters, it has high light transmittance.

With the reflective liquid crystal element 16, a semiconductor such as silicon can be used as a substrate as described above, and this makes it possible to fabricate a compact, highly-integrated liquid crystal element 16. In addition, the above-mentioned switching devices and the peripheral circuits including wiring conductors can be arranged on the back surface of that substrate (its surface opposite from the display side), and this makes it possible to increase the aperture ratio easily, and thus to display a bright image. Moreover, a ferroelectric liquid crystal has the advantage of fast driving speed, and this makes it possible to adopt time-division driving as described above.

When the rays emerging from the screen center of the liquid crystal element 16 and traveling to the center of the optical pupil E are taken as the principal rays, the reflection angle of the principal rays with respect to the above-mentioned reflective electrodes is 10 degrees or more but less than 40 degrees. Thanks to this reflection angle being 10 degrees or more, the liquid crystal element 16 can be arranged with increased flexibility relative to the observation optical system 18, making the apparatus compact. On the other hand, thanks to the reflection angle being less than 40 degrees, the light reflected from the reflective electrodes can be directed to the observation optical system 18 without undergoing total reflection on a back surface in the liquid crystal sealing base member 22.

The observation optical system 18 is an eyepiece optical system that directs the light emerging from the liquid crystal element 16 to the optical pupil E, and has an axis-asymmetric (rotation-asymmetric, non-axisymmetric) positive optical power. Since the observation optical system 18 is axis-asymmetric, the image light (e.g., the principal rays) entering the observation optical system 18 is inclined relative to the reflective surface (reflective electrodes) of the liquid crystal element 16. Accordingly, the observation optical system 18 may be said to be one that directs to the optical pupil E the image light emerging in the direction inclined relative to the direction perpendicular to the reflective surface of the liquid crystal element 16.

This observation optical system 18 is composed of an eyepiece prism 31, a deflecting prism 32, and a hologram optical element 33.

The eyepiece prism 31 is a first transparent substrate that, on one hand, totally reflects incident light—the image light from the liquid crystal element 16—inside itself to make it advance toward the hologram optical element 33 to direct it via the hologram optical element 33 to the observer's pupil, and that, on the other hand, transmits external light (the light of an outside world image) to direct it to the observer's pupil. The eyepiece prism 31 is, along with the deflecting prism 32, formed of, for example, acrylic resin. The eyepiece prism 31 has the shape of a plane-parallel plate of which a bottom end part is formed increasingly thin downward into a wedge-like shape and of which a top end part is formed increasingly thick upward. The eyepiece prism 31 is bonded to the deflecting prism 32 with adhesive, with the hologram optical element 33, which is disposed on the bottom end part of the former, in between.

The deflecting prism 32 is a second transparent substrate that is formed out of a substantially U-shaped plane-parallel'plate as seen in a plan view (see FIG. 2) and that, when bonded to the bottom end part and both side parts (left and right end surfaces) of the eyepiece prism 31, forms together with it a substantially plane-parallel plate as a single unit. Bonding the deflecting prism 32 and the eyepiece prism 31 together helps prevent distortion in the outside world image that the observer observes via the observation optical system 18.

Specifically, for example, if the eyepiece prism 31 and the deflecting prism 32 were not bonded together, external light would be refracted when passing through the wedge-shaped bottom end part of the eyepiece prism 31, causing distortion in the outside world image observed through the eyepiece prism 31. By contrast, bonding the eyepiece prism 31 and the deflecting prism 32 together to form a substantially plane-parallel plate as a single unit makes it possible to cancel the refraction that external light suffers when passing through the wedge-shaped bottom end part of the eyepiece prism 31 by the deflecting prism 32. Thus, it is possible to prevent distortion in the outside world image observed through the eyepiece prism 31.

The hologram optical element 33 is a volume-phase reflective hologram that diffracts the light of each of the wavelengths corresponding to three primary colors emerging from the liquid crystal element 16 to direct it to the observer's pupil. The hologram optical element 33 has an optically axis-asymmetric positive optical power, and functions equivalently to an aspherical concave-surface mirror. This increases the flexibility with which the optical components constituting the apparatus can be arranged, contributing to easy miniaturization of the apparatus, and makes it possible to present a satisfactorily aberration-corrected image to the observer.

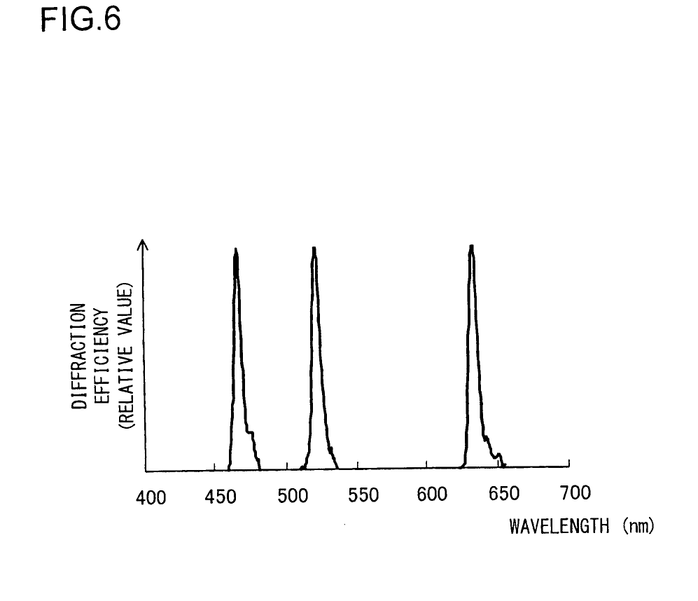

FIG. 6 is a diagram illustrating the wavelength dependence of diffraction efficiency in the hologram optical element 33. As shown there, the hologram optical element 33 is so fabricated as to diffract (reflect) light in three wavelength ranges of, for example, 465±5 nm (B light), 521±5 nm (G light), and 634 ±5 nm (R light) as expressed in terms of the diffraction-efficiency peak wavelength and the diffraction-efficiency half-value wavelength width. Here, the diffraction-efficiency peak wavelength denotes the wavelength at which diffraction efficiency has a peak, and the diffraction-efficiency half-value wavelength width denotes the whole wavelength width within which diffraction efficiency is equal to or more than half the diffraction efficiency at a peak. In FIG. 6, diffraction efficiency is given in values relative to the maximum diffraction efficiency of B light taken as 100.

Since the hologram optical element 33 is fabricated so as to diffract light of predetermined wavelengths incident at predetermined incidence angles as described above, it hardly affects the transmission of external light. Thus, the observer can view an outside world image via the eyepiece prism 31, the hologram optical element 33, and the deflecting prism 32.

Furthermore, the numerical relationship described above may be said to indicate that the diffraction-efficiency peak wavelengths of the hologram optical element 33 substantially coincide with the intensity peak wavelengths (center wavelengths) of the light emitted from the light source 11. With this configuration, of the light emitted from the light source 11, light around the wavelengths at which light intensity has peaks is efficiently diffracted by the hologram optical element 33; thus, despite superimposition on an outside world image, a bright, viewable image can be presented to the observer. Moreover, the optical pupils for different colors coincide in the Y direction, contributing to a small overall optical pupil E.

### 3. Operation of Image Display Apparatus

Next, the operation of the image display apparatus 1 constructed as described above will be described with reference to FIG. 3.

The light (e.g., P-polarized light) of different colors, namely R, G, and B, emitted on a time-division basis from the light source 11 is first transmitted through the polarizer plate 12, and is then incident via the polarizer 15 and the unidirectional diffuser plate 14 on the mirror 13, on which it is reflected. The light reflected from the mirror 13 (P-polarized light) enters the unidirectional diffuser plate 14 again, where it is diffused, and is then transmitted through the polarizer 15 to be incident on the liquid crystal element 16.

The liquid crystal element 16 reflects the incident light, when the light is phase-modulated on a pixel-by-pixel basis according to image data for each of R, G, and B. For example, at a pixel where black is to be displayed, the incident light is not phase-modulated and emerges, unchanged as P-polarized light, from the liquid crystal element 16 to be absorbed by the analyzer 17. On the other hand, at a pixel where white is to be displayed, the liquid crystal element 16 acts as a quarter-wave plate; thus the incident light is thereby converted into S-polarized light and is transmitted through the analyzer 17. By controlling the modulation duration in the liquid crystal element 16 or the intensity of light emitted from the light source 11, it is possible to display a color image on the LCD. It is arbitrary whether to use P- or S-polarized light to display white.

The image light transmitted through the analyzer 17 enters the eyepiece prism 31 of the observation optical system 18 via a surface 31 a having a convex curved surface. Inside the eyepiece prism 31, the image light is totally reflected a plurality of times on two opposite flat surfaces (surfaces 31b and 31c) of the eyepiece prism 31, and is thereby guided to the hologram optical element 33 provided at the bottom end of the eyepiece prism 31, where the image light is then reflected to be directed to the optical pupil E. Thus, at the position of the optical pupil E, the observer can observe, as a color image, enlarged virtual images of R, G, and B images displayed one at a time on the LCD.

On the other hand, the eyepiece prism 31, the deflecting prism 32, and the hologram optical element 33 transmit almost all light from the outside world, and thus the observer can observe an outside world image on a see-through basis. Thus, the virtual image of the image displayed on the LCD is observed in a form superimposed on part of the outside world image.

As described above, in the image display apparatus 1 of this embodiment, the hologram optical element 33 of the observation optical system 18 is used as a combiner that directs the image light from the LCD and external light simultaneously to the observer's pupil. Thus, the observer can observe, via the hologram optical element 33, the image provided from the LCD and an outside world image simultaneously.

Since the hologram optical element 33 exhibits higher diffraction efficiency to S-polarized light than to P-polarized light, by letting S-polarized light emerge from the liquid crystal element 16 and be transmitted through the analyzer 17 as in this embodiment, it is possible to present a bright image with high color purity to the observer. It is instead possible to let P-polarized light emerge from the liquid crystal element 16 and convert it, after its passage through the analyzer 17, into S-polarized light with a quarter-wave plate.

Since the deflecting prism 32 cancels refraction of external light at the wedge-shaped part of the eyepiece prism 31, the observer can observe external light without distortion through the eyepiece prism 31, the deflecting prism 32, and the hologram optical element 33. Since the image light is directed to the eye by reflection inside the eyepiece prism 31, the eyepiece prism 31 can be made as thin (e.g., about 3 mm) as a common lens for eye glasses, contributing to compactness and light weight. Since reflection inside the eyepiece prism 31 is total reflection, the observer can observe the outside world image through the surfaces 31b and 31c of the eyepiece prism 31 with no loss in transmittance of external light.

With the ferroelectric liquid crystal element 16, when it is not acting as a phase plate, it displays black. In this state, liquid crystal molecules have their major-axis direction aligned with the polarization direction of the incident light, and thus do not change the polarization direction of the incident light. Accordingly, even when light is incident on the reflective surface of the liquid crystal element 16 from an oblique direction, little light leaks through black display, allowing high-contrast display. On the other hand, when white is displayed, the liquid crystal element 16 acts as a quarter-wave plate, and thus the intensity of the light transmitted through the analyzer 17 varies with wavelength (wavelength dependence); this wavelength dependence can be canceled by adjusting the intensity of the light emitted from the light source 11 and the modulation duration in the liquid crystal element 16.

In this embodiment, the analyzer 17 is the only optical member disposed in the optical path between the liquid crystal element 16 and the observation optical system 18, meaning that there is a hollow space there in which no optical member such as an illuminating prism is disposed. This eliminates likelihood of unnecessary reflection on an interior surface of such a prism, and makes it possible to present a bright image to the observer.

In this embodiment, the light source 11 and the optical pupil E are in a positionally conjugate relationship with each other. Since the reflective liquid crystal element 16 has a high aperture ratio as described above, diffusion at each pixel of the liquid crystal element 16 is small. Accordingly, the light source 11 and the optical pupil E may be said to be optically substantially conjugate in the Y-direction. On the other hand, in the X direction, since the mirror 13 has no optical power, the light source 11 and the optical pupil E are not optically conjugate. The mirror 13 is so arranged that, after it condenses the light from the light source 11, the light diffused by the unidirectional diffuser plate 14 efficiently forms the optical pupil E, and thus it is possible to observe a bright image at the position of the optical pupil E.

In this embodiment, the optical arrangement and optical powers of the individual optical members are set such that the optical pupil E measures 6 mm in the X direction and 2 mm in the Y direction in terms of intensity half-value widths. The optical pupil is so formed that its size in the Y direction is, as a result of 0.5-degrees diffusion at the unidirectional diffuser plate 14 and about 2-degree diffusion at the liquid crystal element 16, slightly larger than the size determined by the light emission area (e.g., 0.3 mm square) of the light source 11 and the image magnification of the conjugate relationship.

As described above, in one direction (X direction), the optical pupil E, measuring 6 mm, is larger than the human pupil (about 3 mm), making it easier for the observer to observe the image. On the other hand, in the other direction (Y direction), the optical pupil E, measuring 2 mm, is smaller than the human pupil, permitting the light from the light source 11 to be condensed at the optical pupil E without loss in that direction. This allows the observer to observe a bright image. Thus, when the observer observes the image, by aligning the X and Y directions with the observer's left/right and up/down directions respectively, he can observe the image with ease with the pupil large in the left/right direction, in which the observer's eye moves easily and has a wide observation range, and with satisfactory brightness with light condensed at the pupil small in the up/down direction.

As shown in FIG. 4, the light from the light source 11 with a small light emission area is diffused by the unidirectional diffuser plate 14 in the X direction perpendicular to the optical axis incidence surface of the hologram optical element 33, then passes, via a lens 13′, through the unidirectional diffuser plate 14 again, and then illuminates the liquid crystal element 16. Here, the unidirectional diffuser plate 14 diffuses the light from a plurality of light-emitting portions and then emits it. Thus, when the image light from the liquid crystal element 16 is directed via the observation optical system 18 to the optical pupil E, at the position of the optical pupil E, the observer can observe, as a virtual image, a high-quality image with no brightness or color unevenness. By bonding or pasting the surface of the unidirectional diffuser plate 14 not involved in diffusion to the polarizer 15 and thereby reducing reflection at the interface, it is possible to present a more uniform and brighter image to the observer.

In each of the light source groups 11P and 11Q of the light source 11, the light-emitting portions 11R₁, 11G₁, and 11B₁, or 11R₂, 11G₂, and 11B₂, are arranged substantially along the X direction, and thus the plurality of LEDs may be said to be arranged substantially along the diffusion direction of the unidirectional diffuser plate 14. This makes it possible to diffuse the light emitted from the individual LEDs in the diffusion direction of the unidirectional diffuser plate 14 and thereby present a satisfactory color image with no color unevenness to the observer.

### 4. Reduction of Color Unevenness Through Setting of Optical Pupil

In this embodiment, as described above, the optical pupil E is set so as to measure 6 mm in the X direction and 2 mm in the Y direction in terms of intensity half-value widths. That is, the optical pupil E is larger in the X direction, i.e., the direction perpendicular to the optical axis incidence surface (YZ plane) of the hologram optical element 33, than in the Y direction, i.e., the direction parallel to the optical axis incidence surface. Setting the size of the optical pupil E that way allows the observer to observe a high-quality image with little color unevenness without being much affected by the wavelength characteristic (wavelength selectivity) of the hologram optical element 33. The reasons are as follows.

First, a description will be given of the relationship between incidence angle and wavelength selectivity in the hologram optical element 33. In the hologram optical element 33 having interference fringes that diffract light having incident angles greater than 0 degrees, wavelength selectivity is lower (a deviation in diffraction wavelength due to a deviation in incidence angle is smaller) in the direction perpendicular to the optical axis incidence surface than in the direction parallel to the optical axis incidence surface. In other words, angle selectivity for a deviation in incidence angle with respect to the interference fringes is lower in the direction perpendicular to the optical axis incidence surface than in the direction parallel to the optical axis incidence surface. This is because, when light is incident on the interface fringes of the hologram optical element 33 with an incidence angle, a deviation in incidence angle within the optical axis incidence surface makes as large a deviation in incidence angle, and thus greatly affects diffraction wavelength, whereas a deviation in incidence angle in the direction perpendicular to the optical axis incidence surface is small for a deviation in incidence angle, and thus little affects diffraction wavelength.

Accordingly, when light is incident on the interference fringes of the hologram optical element 33 with an angle deviated from a predetermined incidence angle, the same deviation in angle, if it is in the Y direction parallel to the optical axis incidence surface, causes a greater deviation in diffraction wavelength than if the deviation in angle is in the X direction perpendicular to the optical axis incidence surface (i.e., wavelength selectivity is higher in the Y direction parallel to the optical axis incidence surface).

Accordingly, forming the optical pupil E small in the Y direction in which diffraction wavelength varies greatly helps narrow the range of the variation in diffraction wavelength, and thus helps reduce color unevenness at the optical pupil E. Moreover, even when the optical pupil E is formed large in the X direction perpendicular to the optical axis incidence surface, an image with high color purity can be presented to the observer. The incidence plane of light outside the optical axis incidence surface is slightly deviated from parallel to the optical axis incidence surface, but since a deviation in angle in the direction perpendicular to the optical axis incidence surface little affects diffraction wavelength as described above, using the optical axis incidence surface as a reference does not result in undue color unevenness.

### 5. Reduction of Color Unevenness Through Arrangement of Light-Emitting Portions of Light Source

As shown in FIG. 4, the light-emitting portions of the light source groups 11P and 11Q constituting the light source 11 are arranged substantially along the X direction perpendicular to the optical axis incidence surface of the hologram optical element 33. As described above, the hologram optical element 33 exhibits lower wavelength selectivity in the X direction perpendicular to the optical axis incidence surface than in the Y direction parallel to the optical axis incidence surface, and thus arranging the light-emitting portions substantially along the X direction allows the observer to observe a high-quality image with no color unevenness.

In addition, in this embodiment, the light-emitting portions are arranged substantially symmetrically about the optical axis incidence surface, that is, such that two light-emitting portions emitting light of the same light are located in opposite directions substantially equidistantly from the optical axis incidence surface. More specifically, in the light source group 11P, the light-emitting portions 11R₁, 11G₁, and 11B₁ are arranged in this order increasingly out along the X direction from the optical axis incidence surface side; likewise, in the light source group 11Q, the light-emitting portions 11R₂, 11G₂, and 11B₂ are arranged in this order increasingly out along the X direction from the optical axis incidence surface side.

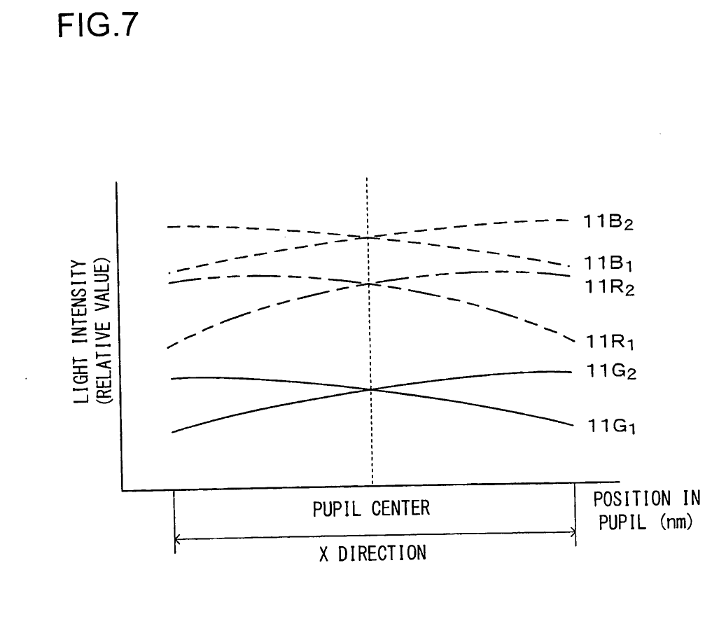

FIG. 7 is a diagram illustrating the relationship between position within the optical pupil E in the X direction and light intensity. For each color, light intensity is given in relative values. The curves indicated by 11R₁, 11R₂, 11G₁, 11G₂, 11B₁, and 11B₂ correspond to the light emitted from the light-emitting portions 11R₁, 11R₂, 11G₁, 11G₂, 11B₁, and 11B₂ respectively.

By arranging the light-emitting portions substantially symmetrically color-to-color about the optical axis incidence surface as described above, it is possible to locate, within the plane of symmetry (within the optical axis incidence surface), the center of gravity of the total—summed—intensity of light emitted from two light-emitting portions (11R₁ and 11R₂) of the same color, for each of R, G, and B. That is, for each of R, G, and B, it is possible to make its intensity distribution symmetric in the X direction about the plane of symmetry. This makes it possible to present an image with little color unevenness to the observer at the center of the optical pupil E.

Owing to the angle selectivity of the hologram optical element 33, the longer the wavelength of light, the smaller the optical pupil. Accordingly, as shown in FIG. 7, the longer the wavelength of light, the greater the intensity difference between different positions in the pupil (the greater the intensity difference between the center and edge of the optical pupil E). Thus, by arranging the light-emitting portions in such order that the wavelength of emitted light is increasingly short outward along the X axis from the optical axis incidence surface side, and thereby locating the high-light-intensity positions closer to the center of the optical pupil E the longer the wavelength of light, it is possible to increase the efficiency of use of the light at the optical pupil E.

On the other hand, the shorter the wavelength of light, the larger the optical pupil; thus, the shorter the wavelength of light, the smaller the intensity difference between different positions in the pupil. That is, the shorter the wavelength of light, the farther the high-light-intensity positions are located away from the center of the optical pupil E, and thus the smaller the intensity difference between the peak and peripheral intensities. Thus, no significant drop in light use efficiency results. This contributes to, for each color, a small intensity difference, and hence small brightness unevenness (color unevenness), within the optical pupil E.

### 6. Back Surface Reflection Light Reducer

Next, the back surface reflection light reducer of the liquid crystal element 16 will be described.

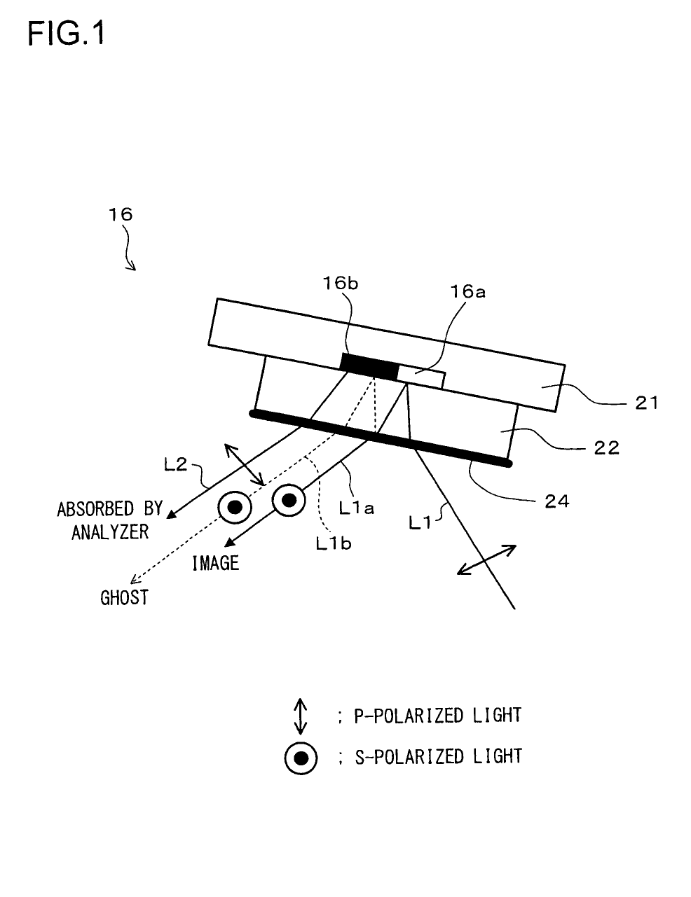

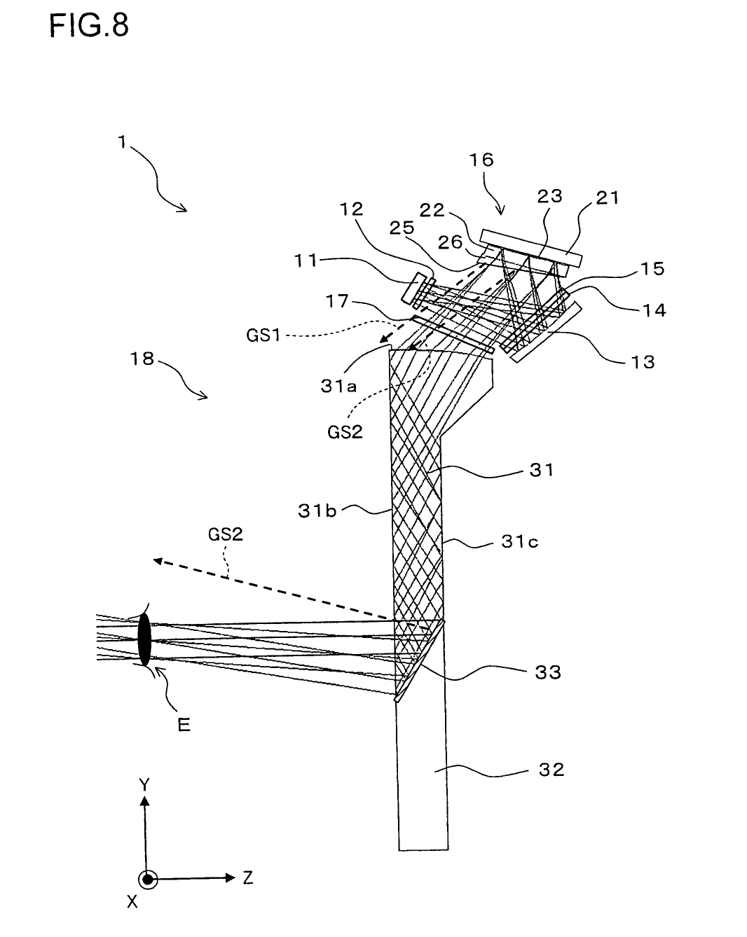

The back surface reflection light reducer is a back surface reflection light reducing means for reducing the incidence, on the optical pupil E, of the light that enters the liquid crystal element 16 from the outer, air side via the second base member (e.g., the liquid crystal sealing base member 22), that is then reflected on a reflective electrode, that is then reflected on a back surface in the second base member, and then emerges to the air side via another reflective electrode. The back surface reflection light reducer is composed of, for example, a back surface reflection prevention coating 24 as shown in FIG. 1 or an inclined surface 25 as shown in FIG. 8. Here, reflection on a back surface in the second base member denotes the reflection of light (image light) reflected from a reflective electrode in the liquid crystal element 16 which takes place at the interface between the second base member and an air layer. Different types of the back surface reflection light reducer will be described one by one below.

### 6-1. Back Surface Reflection Prevention Coating

FIG. 1 is a sectional view showing the detailed structure of the liquid crystal element 16. The liquid crystal element 16 has a back surface reflection prevention coating 24. The back surface reflection prevention coating 24 is an optical thin coating that reduces back surface reflection in the liquid crystal sealing base member 22. The back surface reflection prevention coating 24 is formed of, for example, a multiple-layer dielectric thin coating, and coats the air-side surface of the liquid crystal sealing base member 22. The back surface reflection prevention coating 24 has a reflectance of, for example, 0.5% or less.

In the construction in which the reflective liquid crystal element 16 is used as a light-modulating device and the image light emerging in a direction inclined relative to the direction perpendicular to the reflective surface of the liquid crystal element 16 is directed via the observation optical system 18 to the optical pupil E, if the back surface reflection prevention coating 24 is not provided, when light L1 is incident from an oblique direction on a given pixel 16a (reflective electrode) of the liquid crystal element 16, the light reflected from the pixel 16a is incident from an oblique direction on a back surface in the liquid crystal sealing base member 22. Part of the light (light L1a) emerges to the air side without being reflected on the back surface in the liquid crystal sealing base member 22, but the rest of the light (light L1b) is reflected on the back surface in the liquid crystal sealing base member 22, and is then reflected again on another pixel 16b (reflective electrode) of the liquid crystal element 16.

Here, suppose that the pixel 16a is one that displays white by modulating the phase of the incident light L1 (by converting P-polarized light into S-polarized light) and that the pixel 16b is one that displays black without changing the phase of the incident light L1 (without converting P-polarized light into S-polarized light). Then, the back reflection light (light L1b) of the white-displaying image light emerging from the pixel 16a may overlap the regular black-displaying image light (light L2) emerging from the pixel 16b, causing a ghost. Specifically, when the light L1 incident on the pixel 16a is P-polarized, the light emerging from the pixel 16a is S-polarized, and, of this light, the light L1b reflected on a back surface in the liquid crystal sealing base member 22 and emerging via the pixel 16b remains S-polarized, is thus transmitted through the analyzer 17, and thus may cause a ghost. Since the liquid crystal sealing base member 22 (e.g., glass) has a refractive index of about 1.5, it has a back surface reflectance of about 5%; thus, in black-displaying parts, a bright ghost appears with light intensity of about 1/20 of that in white-displaying parts, resulting in low contrast.

In this embodiment, however, since the air-side surface of the liquid crystal sealing base member 22 is coated with the back surface reflection prevention coating 24, it is possible to surely reduce the very generation of back surface reflection light (light L1b) in the liquid crystal sealing base member 22, and thus to reduce the incidence of back surface reflection light on the optical pupil E. That is, in the example described above, the image light emerging from the white-displaying pixel 16a can be extracted, as the light L1a, to the air side via the liquid crystal sealing base member 22 with almost no back surface reflection, and the light L1a can be directed via the observation optical system 18 to the optical pupil E; thus it can be prevented from overlapping black display and causing a ghost. When the back surface reflection prevention coating 24 has a reflectance of 0.5% or less as in this embodiment, even if a ghost appears in black-displaying parts, the ghost is dim with light intensity as low as 1/200 or less of that in white-displaying parts, and thus it is possible to display a high-contrast image.

Thus, even with a construction in which back surface reflection light greatly affects display quality as in this embodiment, specifically the construction that employs the reflective liquid crystal element 16 and in which image light emerges in a direction inclined relative to the direction perpendicular to the reflective surface of the liquid crystal element 16 and is directed via the axis-asymmetric observation optical system 18 to the observer's pupil, it is possible to prevent a lowering in the contrast of the displayed image and allow the observer to observe an image with satisfactory display quality.

In particular, in this embodiment, ferroelectric liquid crystal is used as the liquid crystal 23 of the liquid crystal element 16. Ferroelectric liquid crystal has a wider viewing angle characteristic than, and is in this respect superior to, TN (twisted nematic) liquid crystal, and offers an image with high contrast, high color reproducibility, and high display quality even with large incidence and reflection angles with respect to the reflective surface of the liquid crystal element 16. Accordingly, when the reflective liquid crystal element 16 is built by use of ferroelectric liquid crystal with such a characteristic and it is applied to the image display apparatus 1 of this embodiment that allows the observer to observe an image by use of image light emerging in an oblique direction from the reflective liquid crystal element, the invention's above-described effect of preventing a lowering in the contrast of the displayed image and allowing observation of an image with satisfactory display quality is very effective.

Instead of the back surface reflection prevention coating 24, a back surface reflection prevention film may be used as the back surface reflection light reducer. Specifically, instead of the surface of the liquid crystal sealing base member 22 being coated with the back surface reflection prevention coating 24, the surface may have a back surface reflection prevention film affixed to it.

### 6-2. Inclined Surface

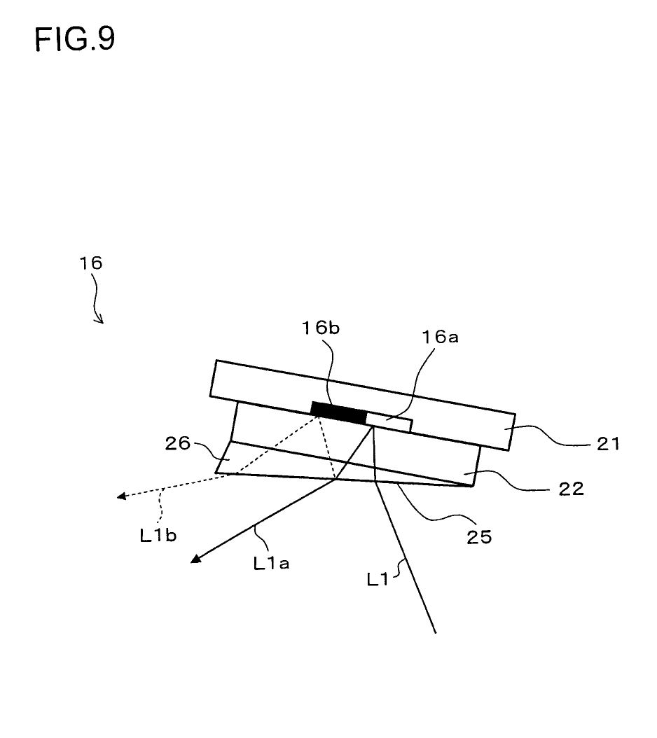

FIG. 8 is a sectional view schematically showing another construction of the image display apparatus 1. FIG. 9 is a sectional view showing the detailed structure of the liquid crystal element 16 applied to this image display apparatus 1. As shown in these figures, the liquid crystal element 16 may have, instead of the back surface reflection prevention coating 24 (see FIG. 1), an inclined surface 25 as the back surface reflection light reducer.

The inclined surface 25 is the most air-side surface of the liquid crystal element 16 inclined relative to the reflective surface of the liquid crystal element 16. More specifically, the inclined surface 25 is so inclined as to form an angle relative to the reflective surface of the liquid crystal element 16 within the optical axis incidence surface of the hologram optical element 33, that is, within the plane of symmetry of the observation optical system 18. The inclination angle of the inclined surface 25 will be described in detail later.

The inclined surface 25 as described above is, in this embodiment, formed by bonding, with adhesive, a wedge-shaped prism 26 to the liquid crystal sealing base member 22, which is a plane-parallel plate, and the air-side surface of the prism 26 serves as the inclined surface 25 mentioned above. The adhesive here has a refractive index substantially equal to those of the prism 26 and the liquid crystal sealing base member 22 (e.g., about 1.5), and this reduces reflection at the interface between these. Needless to say, the liquid crystal sealing base member 22 and the wedge-shaped prism 26 may be formed as a single unit. In either case, the liquid crystal sealing base member 22 and the wedge-shaped prism 26 can together be regarded as a single second base member, and therefore, here, reflection at the interface between the inclined surface 25 and the air layer will be called back surface reflection in the second base member.

In FIG. 9, as in FIG. 1, when, of light L1 incident from an oblique direction on the liquid crystal element 16, the light that emerges from a given pixel (e.g., pixel 16a) to the air side without undergoing back surface reflection is referred to as light L1a and the light that emerges from the same pixel, that then undergoes back surface reflection in the second base member, that is then reflected on another pixel (e.g., pixel 16b), and that then emerges via the second base member to the air side is referred to as light L1b, the inclined surface 25 is so inclined relative to the reflective surface (reflective electrode) of the liquid crystal element 16 that, of the light L1a and L1b, the light L1b has a larger emergence angle than the light L1a. Here, however, the incidence direction of the light L1 with respect to the liquid crystal element 16 is such that the emergence angle of the light L1a with respect to the inclined surface 25 is larger than the incidence angle of light L1 with respect to the inclined surface 25. It should be noted that all incidence and emergence angles mentioned in the present specification are those relative to a line normal to the inclined surface 25.

In the construction where the liquid crystal element 16 is provided with the inclined surface 25, as shown in FIG. 8, as a result of refraction at the inclined surface 25, some of the back surface reflection light (the light L1b) emerges from the liquid crystal element 16 but does not enter the eyepiece prism 31 of the observation optical system 18, while the rest enters the eyepiece prism 31. For the sake of convenience of description, the back surface reflection light that emerges from the liquid crystal element 16 and does not enter the eyepiece prism 31 will be refereed to as unnecessary light GS1, and the back surface reflection light that enters the eyepiece prism 31 will be referred to as unnecessary light GS2.

Since the unnecessary light GS1 emerges from the liquid crystal element 16 but does not enter the eyepiece prism 31, it naturally does not reach the optical pupil E; thus, no ghost ascribable to the unnecessary light GS1 is observed. On the other hand, the unnecessary light GS2 does enter the eyepiece prism 31 but emerges to such a position as not to be directed to the optical pupil E; thus, a ghost ascribable to the unnecessary light GS2 is hardly likely to be observed at the position of the optical pupil E. Even if the unnecessary light GS2 is, along with the regular image light, diffracted by the hologram optical element 33, since the hologram optical element 33 has angle selectivity, only light with very low intensity emerges; thus, a ghost is hardly likely to be observed at the position of the optical pupil E.

As a result of the liquid crystal element 16 having the inclined surface 25 as described above, the back surface reflection light in the second base member is eventually refracted at the inclined surface 25 when exiting from the liquid crystal element 16. Thus, at least part of the back surface reflection light can be diverted from the optical path leading to the optical pupil E. That is, the incidence of the back surface reflection light on the optical pupil E is reduced. This makes it possible to surely prevent a lowering in the contrast of the displayed image, and thereby to surely enhance the display quality of the image.

In particular, the inclined surface 25 is so inclined relative to the reflective surface (reflective electrode) of the liquid crystal element 16 that, of the regular image light L1a and the back surface reflection light, the light L1b has a larger emergence angle than the light L1a. As a result, when refracted at the inclined surface 25 while traveling out of the second base member into air, the back surface reflection light is refracted more than the regular light, producing a larger angle deviation and thereby making ghost reduction easier.

The liquid crystal element 16, with the inclined surface 25, exerts a refracting effect on the image light emerging from it as described above. Thus, inclining the inclined surface 25 in the direction in which it forms an angle relative to the reflective surface of the liquid crystal element 16 within the plane of symmetry of the observation optical system 18 makes it easy to cancel, with the aberrations resulting from refraction at the inclined surface 25, and thereby correct the aberrations occurring in the axis-asymmetric observation optical system 18 (in particular, the eyepiece prism 31). This makes it possible to present a high-quality image to the observer.

In this embodiment, by use of the unidirectional diffuser plate 14 described above, the direction of the inclination of the inclined surface 25 is aligned with the direction in which the diffusion by the unidirectional diffuser plate 14 is small (the Y direction in which the optical pupil E is small). As a result, when the light emitted from the light source 11 is diffused by the unidirectional diffuser plate 14, the beam diameter of that light is smaller in the Y direction than in the X direction. Accordingly, even with a small inclination of the inclined surface 25, it is easy to divert at least part of the back surface reflection light in the second base member from the optical path leading to the optical pupil E. Thus, with a small inclination angle of the inclined surface 25, it is possible to obtain the effect of ghost reduction (the smaller the optical pupil E, the more powerful the effect of ghost reduction attributable to the inclination of the inclined surface 25). This makes it possible to make the second base member thinner and thereby make the apparatus lighter.

The diffusion direction (the X direction) of the unidirectional diffuser plate 14 also is perpendicular to the optical axis incidence surface of the hologram optical element 33. As described previously, wavelength selectivity is lower, and thus the diffraction efficiency of the hologram is higher, in the direction perpendicular to the optical axis incidence surface than in the direction parallel to the optical axis incidence surface. Accordingly, as a result of the diffusion direction of the unidirectional diffuser plate being aligned with the direction perpendicular to the optical axis incidence surface of the hologram optical element, it is possible, while obtaining the above-mentioned effect of ghost reduction with a small inclination angle of the inclined surface 25, to form an optical pupil E large in the X direction, thereby to allow the observer to observe a bright image with high color purity and high contrast.

### 6-3. Inclination Angle of Inclined Surface

Next, the inclination angle of the inclined surface 25 will be described.

The inclination angle of the inclined surface 25 relative to the reflective surface of the liquid crystal element 16 is set at, for example, 1.5 degrees. In this case, the back surface reflection light emerges into air with an angle deviation of 4.5 degrees relative to the emergence angle of the regular image light, the angle deviation being about three times the inclination angle, accounted for by an angle deviation twice the inclination angle (due to back surface reflection on the inclined surface 25 and reflection on a reflective electrode thereafter) plus an angle deviation due to refraction at the inclined surface 25 of the second base member (with a refractive index of about 1.5).

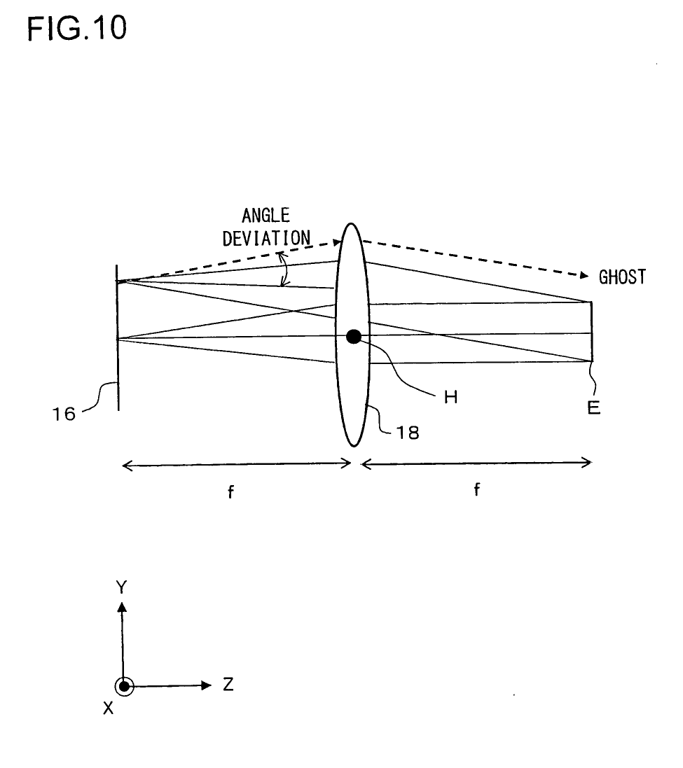

FIG. 10 is an illustrative diagram of the optical path as straightened with the observation optical system 18 replaced with a single lens. The focal length f of the observation optical system 18 is, for example, 20 mm, and the optical pupil E is formed at a distance close to the focal length f from the principal point H of the observation optical system 18; thus, light with an angle deviation about three times the inclination angle (the back surface reflection light) emerges to, near the optical pupil E, a position 20×tan 4.5°=1.5 mm away from the center of the pupil in the Y direction, thus traveling outside the optical pupil E (2 mm in the Y direction). Thus, at the position of the optical pupil E, hardly any ghost ascribable to the back surface reflection light is observed. Incidentally, even when the optical pupil is made larger than 2 mm in the Y direction, since the observer's pupil is normally about 3 mm, the back surface reflection light reaches around the observer's pupil, producing a ghost which is a dim image.

Even when the inclination angle of the inclined surface 25 is set at, for example, 1 degree, light with an angle deviation about three times the inclination angle emerges to a position about 1.05 mm (20×tan 3°) away from the center of the pupil in the Y direction. Accordingly, even in a case where the back surface reflection light of the light emerging from a white displaying pixel 16a emerges via a black-displaying pixel 16b, at the position of the optical pupil E, either a dim ghost or no ghost is observed, allowing display of a high-contrast image.

When the inclination angle of the inclined surface 25 is set at, for example, about 5 degrees, light with an angle deviation about three times the inclination angle emerges to a position about 5.4 mm (20×tan 15°) away from the center of the pupil in the Y direction. In this case, even making the optical pupil E as large as 10 mm in the Y direction permits either a sufficiently dim ghost or no ghost to be observed.

On the other hand, it is preferable that the inclination of the inclined surface 25 be set at an angle as small as 10 degrees or less. Setting the inclination angle as small as 10 degrees or less in this way helps make the second base member thin, and thus makes it easy to make the liquid crystal element 16 compact and light and to secure the illumination optical path.

Based on the foregoing, it may be said that, to make the liquid crystal element 16, and hence the image display apparatus 1, compact and light while achieving ghost reduction, it is preferable that the inclination angle of the inclined surface 25 be set at 1 degrees or more but 10 degrees or less.

With the inclination angle of the inclined surface 25 set at 5 degrees or more but 10 degrees or less, it is possible to obtain effects similar to those mentioned above while realizing an apparatus with a large optical pupil E offering enhanced image viewability. Even with an optical pupil E sufficiently large in a virtual-image system to permit back surface reflection light to emerge to, near the optical pupil E, a position about 11.5 mm (20×tan 30°) from the center of the pupil, it is possible to obtain a sufficient effect of ghost reduction.

The focal length of the observation optical system 18 is, through arbitrary, set at 15 mm at the shortest, or more; thus, back surface reflection light emerges to substantially the same position as when the focal length is 20 mm. When the focal length of the observation optical system 18 is set longer than 20 mm, the position to which back surface reflection light emerges is farther away from the optical pupil E; this permits a still dimmer ghost or no ghost to be observed.

The above description deals with an example in which the inclined surface 25 is inclined in the direction in which it forms an angle relative to the reflective surface of the liquid crystal element 16 within the plane of symmetry of the observation optical system 18. Here, the inclination angle of the inclined surface 25 relative to the reflective surface is as small as 10 degrees or less, and thus the degree of refraction at the inclined surface 25 is not high. Accordingly, the inclined surface 25 may instead be inclined in a direction in which the aberrations of the eyepiece prism 31 are not corrected. Instead, the inclined surface 25 may be inclined in the direction in which it forms an angle relative to the reflective surface within the plane perpendicular to the plane of symmetry of the observation optical system 18. In that case, the observation optical system 18 may also be made asymmetric about the YZ plane to correct the refraction by the inclined surface 25.

### 6-4. Application of Inclined Surface to Other Image Display Apparatuses

Alternatively, the inclined surface 25 of the liquid crystal element 16 may be so inclined relative to the reflective surface that, of the light L1 entering the second base member from the reflective surface (a reflective electrode), the light L1b that undergoes back surface reflection in the second base member and that then emerges from the second base member via another reflective electrode has a smaller emergence angle than the light L1a that emerges without undergoing back surface reflection in the second base member. The following description deals with an image display apparatus 1 provided with such an inclined surface 25.

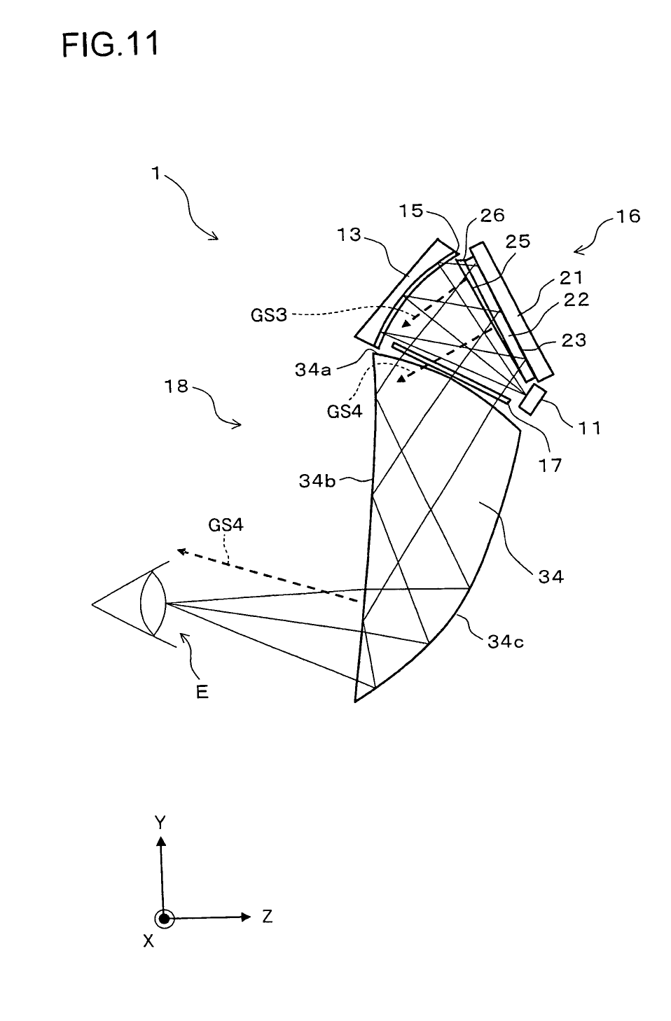

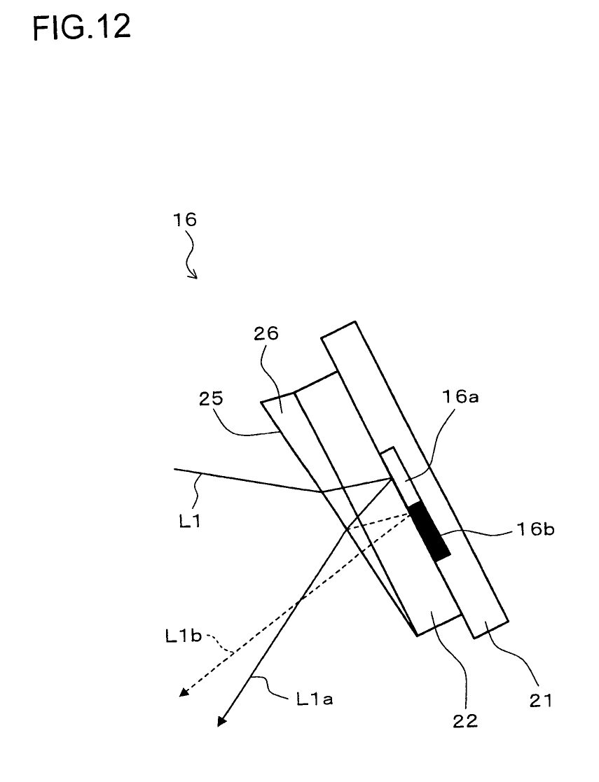

FIG. 11 is a sectional view schematically showing yet another construction of the image display apparatus 1. FIG. 12 is a sectional view showing the detailed structure of a liquid crystal element 16 applied to the image display apparatus 1. The image display apparatus 1 of FIG. 11 greatly differs from the image display apparatus 1 of FIG. 8 in that, whereas the liquid crystal element 16 is in structure the same as the liquid crystal element 16 in FIGS. 8 and 9, the individual optical members are arranged such that the incidence and reflection directions of light with respect to the reflective surface of the liquid crystal element 16 are opposite to those in FIGS. 8 and 9. The differences from the image display apparatus 1 of FIGS. 8 and 9 will now be described.

The light source 11 is disposed on the side opposite from the observer (the optical pupil E) of the optical path of the light traveling from the liquid crystal element 16 to the observation optical system 18. The mirror 13 is so disposed that the light source 11 and the mirror 13 are disposed across that optical path, that is, on the observer side of the optical path.

Here, the mirror 13 is, as in the image display apparatus 1 of FIGS. 3 and 8, composed of a cylindrical concave-surface mirror having no optical power in the X direction. To the surface of the mirror 13, a unidirectional diffuser plate (unillustrated) and a polarizer 15 are bonded in this order. Giving the mirror 13 a cylindrical shape in this way permits the unidirectional diffuser plate and the polarizer 15 to be bonded to the surface of the mirror 13 in a state bent to fit the curve of the mirror 13. This eliminates the need for a member for holding the unidirectional diffuser plate and the polarizer 15. The surface of the polarizer 15 is antireflection-treated to prevent generation of unnecessary light that is reflected on the surface of the polarizer 15 to directly enter the eyepiece prism 31.

The observation optical system 18 is composed of a prism 34. The prism 34 has a first surface 34a, through which light from the liquid crystal element 16 enters the prism 34, a second surface 34b, which faces the optical pupil E and acts as a total-reflection/transmission surface, and a third surface 34c, which is opposite from the second surface 34b and acts as a reflective surface. These three surfaces are all non-rotation-symmetric aspherical surfaces.

In the observation optical system 18 built as described above, the image light from the liquid crystal element 16 enters the prism 34 through the first surface 34a, is then regularly reflected on the second surface 34b, is then reflected on the third surface 34c, and is then transmitted through the second surface 34b to be directed to the optical pupil E. Thus, at the position of the optical pupil E, as with the other image display apparatus 1 described previously, the observer can observe, as a virtual image enlarged in front of his eye, the image displayed on the LCD. In the image display apparatus 1 of FIG. 11, the unillustrated unidirectional diffuser plate diffuses light such that the optical pupil E measures 12 mm in the X direction and 5 mm in the Y direction.

Next, the liquid crystal element 16 applied to the image display apparatus 1 described above will be described. In the image display apparatus 1 of FIG. 11, the inclined surface 25 of the liquid crystal element 16 is inclined about 3 degrees relative to the reflective surface so that the emergence angle of the light L1b is smaller than the emergence angle of the light L1a. Here, however, the incidence direction of the light L1 with respect to the liquid crystal element 16 is, as shown in FIG. 12, such that the emergence angle of the light L1a with respect to the inclined surface 25 is smaller than the incidence angle of the light L1 with respect to the inclined surface 25, and is thus opposite to that in the image display apparatus 1 shown in FIGS. 8 and 9.

Here, of the light L1b, the back surface reflection light that emerges from the liquid crystal element 16 but does not enter the prism 34 will be referred to as unnecessary light GS3, and the back surface reflection light that enters the prism 34 will be referred to as unnecessary light GS4. Since the unnecessary light GS3 emerges from the liquid crystal element 16 but does not enter the prism 34, it naturally does not reach the optical pupil E; thus, no ghost ascribable to the unnecessary light GS3 is observed. On the other hand, the unnecessary light GS4 does enter the prism 34 but emerges to such a position as not to be directed to the optical pupil E; thus, a ghost ascribable to the unnecessary light GS4 is hardly likely to be observed at the position of the optical pupil E.

Specifically, since the inclination angle of the inclined surface 25 is about 3 degrees, the back surface reflection light of the light emerging from a white-displaying pixel 16a in the second base member (the unnecessary light GS4) emerges with an angle deviation of about 10 degrees, which is three times the inclination angle, relative to the regular light, and thus emerges to, near the optical pupil E, a position 3.5 mm (20×tan 10°) from the center of the pupil. Thus, even if the back surface reflection light of the light emerging from a white-displaying pixel emerges via a black-displaying pixel and enters the prism 34, since the optical pupil E measures 5 mm in the Y direction, either a dim ghost or no ghost is observed, allowing display of a high-contrast image.

Since the inclined surface 25 is inclined relative to the reflective surface, the second base member having such an inclined surface 25 exerts, as a wedge-shaped prism, a refracting effect on the image light. Accordingly, setting the refraction at the inclined surface 25 in such a direction as to cancel the refraction occurring at the prism 34 of the observation optical system 18 makes it easy to correct the optical aberrations occurring in the prism 34.

Although this embodiment deals with an example in which ferroelectric liquid crystal is used as the liquid crystal 23 of the liquid crystal element 16, IPS (in-plane switching) liquid crystal may instead be used as the liquid crystal 23. Like ferroelectric liquid crystal, IPS liquid crystal functions as a phase plate, displaying white by converting the phase of polarized light and displaying black without converting the phase of polarized light when the polarization direction of incident light is aligned with the major-axis direction of liquid crystal molecules; it can thus display a high-contrast image. Accordingly, even in a case where IPS liquid crystal is used as the liquid crystal 23, the invention's effect of preventing a lowering in the contrast of the displayed image due to back surface reflection is very effective. The liquid crystal element 16 may be built by use of TN liquid crystal, and may be built to have color filters.

In this embodiment, different examples of image display apparatuses 1 suitable for HMDs have been described. Image display apparatuses according to the embodiment can also be applied to other apparatuses such as head-up displays.

Needless to say, features from different examples of the embodiment described above may be combined to realize an image display apparatus 1 and hence an HMD. For example, needless to say, it is possible to additionally form a back surface reflection prevention coating 24 or a back surface reflection prevention film on the surface of the inclined surface 25 to build the liquid crystal element 16 and build a image display apparatus 1 and hence an HMD by use of that liquid crystal element 16.

Image display apparatuses according to the invention can be applied to, for example, head-up displays and head-mounted displays.

### 7. Supplementary Notes

An image display apparatus according to the invention described above can also be expressed as described below, and it then works and offers benefits as described below.

According to the invention, an image display apparatus is provided with: a light source; a reflective liquid crystal display device for modulating light from the light source to display an image; and an observation optical system that has an axis-asymmetric optical power and that directs image light emerging in a direction inclined relative to the direction perpendicular to a reflective surface of the liquid crystal display device to an optical pupil. The liquid crystal display device is provided with: a liquid crystal element for modulating the light from the light source; a polarizer for transmitting, of the light emitted from the light source, light of a predetermined polarization direction to direct it to the liquid crystal element; and an analyzer for transmitting, of the light emerging from the liquid crystal element, light of a polarization direction perpendicular to the predetermined polarization direction to direct it to the observation optical system. The liquid crystal element is provided with: a first base member that has reflective electrodes formed thereon so as to correspond to individual pixels; a second base member that is transparent; liquid crystal that is held between the first and second base members; and back surface reflection light reducing means for reducing incidence, on the optical pupil, of light that is incident from an outer, air side via the second base member, that is then reflected on a reflective electrode, that is then reflected on a back surface in the second base member, and that then emerges to the air side via another reflective electrode.

The reflective surface of the liquid crystal display device refers to the surface of the reflective electrodes of the liquid crystal element. Reflection on a back surface in the second base member denotes the reflection of light (image light) reflected from a reflective electrode that occurs at the interface between the second base member and the air layer. The second base member refers to, in a case where it has a member (e.g., a prism) provided on its air side integrally with it, their entirety as a whole. The light that is incident from the outer, air side via the second base member, that is then reflected on a reflective electrode, that is then reflected on a back surface in the second base member, and that then emerges via another reflective electrode and the second base member to the air side is referred to also as back surface reflection light.

In the above construction, the light emitted from the light source is modulated by the reflective liquid crystal display device, and is directed via the observation optical system to the optical pupil. More specifically, of the light emitted from the light source, light of a predetermined polarization direction (e.g., P-polarized light) is transmitted through the polarizer of the liquid crystal display device and is incident on the liquid crystal element, which modulates it so that, as image light, light of a polarization direction (e.g., S-polarized light) perpendicular to that of the incident light emerges from the liquid crystal element. This image light is transmitted through the analyzer, and is directed via the observation optical system to the optical pupil. Thus, at the position of the optical pupil, an observer can observe a virtual image of the image displayed by the liquid crystal display device.

Here, the observation optical system has an axis-asymmetric (rotation-asymmetric) optical power. This contributes to increased flexibility in arrangement of the individual optical members constituting the apparatus, and makes it possible to make the apparatus compact and light.

According to the invention, the liquid crystal element is provided with back surface reflection light reducing means. The back surface reflection light reducing means may be, for example, a back surface reflection prevention coating (or back surface reflection prevention film) that is arranged on the air side of the second base member, or an inclined surface that is provided on the most air side of the liquid crystal element and that is inclined relative to the reflective surface. With the former, the very reflection on a back surface in the second base member is reduced, and thus the incidence of the back surface reflection light on the optical pupil is reduced. On the other hand, with the latter, at least part of the back surface reflection light is so refracted by the inclined surface as to be diverted from the optical path leading to the optical pupil, with a result that the incidence of the back surface reflection light on the optical pupil is reduced.

In this way, the back surface reflection light reducing means reduces the incidence of the back surface reflection light on the optical pupil. Thus, even with a construction in which back surface reflection light greatly affects display quality, that is, a construction that employs a reflective liquid crystal display device and in which image light emerges in a direction inclined relative to the direction perpendicular to the reflective surface of the liquid crystal display device and is directed through an axis-asymmetric observation optical system to the observer's pupil, it is possible to prevent a lowering in the contrast of the displayed image, and to allow the observer to observe an image with satisfactory display quality.

In the image display apparatus according to the invention, the liquid crystal may be of the type that modulates incident light by controlling the phase of polarized light.

The liquid crystal is, for example, ferroelectric liquid crystal or IPS liquid crystal. By use of these kinds of liquid crystal, it is possible to display a high-contrast image irrespective of the viewing angle. Accordingly, when such liquid crystal is applied to the image display apparatus according to the invention, the invention's effect of preventing a lowering in the contrast of the displayed image and permitting observation of an image with satisfactory display image is very effective.

In the image display apparatus according to the invention, the back surface reflection light reducing means is composed of an inclined surface which is the air-side surface of the second base member inclined relative to the reflective surface of the liquid crystal display device. When the axis connecting optically between the screen center of the liquid crystal element and the center of the optical pupil is referred to as the optical axis, the observation optical system is formed symmetrically about the plane including the optical axis, and the inclined surface may be inclined in the direction in which it forms an angle relative to the reflective surface within the plane of symmetry.

Back surface reflection light in the second base member is reflected on another reflective electrode, and is eventually refracted at the inclined surface when exiting from the liquid crystal element. Thus, at least part of the back surface reflection light can be diverted from the optical path leading to the optical pupil. This makes it possible to surely prevent a lowering in the contrast of the displayed image, and thereby to surely enhance the display quality of the image.

Inclining the inclined surface as described above makes it possible to easily correct the aberrations occurring in the axis-asymmetric observation optical system with the aberrations occurring by refraction at the inclined surface, and thus allows observation of an image with high image quality.

In the image display apparatus according to the invention, the inclined surface may be so inclined that, of the light entering the second base member from a reflective electrode, the light that undergoes back surface reflection in the second base member and that emerges from the second base member via another reflective electrode has a larger emergence angle than the light that emerges without undergoing back surface reflection in the second base member.

The inclined surface inclined as described above permits the back surface reflection light to emerge from it in a direction different from the regular image light, with a large angle difference. This enhances the effect of reducing ghosts due to back surface reflection and preventing a lowering in the contrast of the displayed image.

In the image display apparatus according to the invention, it is preferable that the inclined surface be inclined with an inclination angle of 1 degree or more relative to the reflective surface. This permits the back surface reflection light to emerge with an angle deviation about three times the inclination angle of the inclined surface relative to the regular image light so as to be directed to around the observer's pupil (e.g., about 3 mm). This reduces the likelihood of a ghost due to back surface reflection light being observed by the observer.

In the image display apparatus according to the invention, it is preferable that the inclined surface be inclined with an inclination angle of 10 degrees or less relative to the reflective surface. This makes it possible to make the second base member thin, and thus makes it possible to make the liquid crystal element and hence the image display apparatus compact and light.

The image display apparatus according to the invention may be further provided with a reflective member for reflecting the light from the light source toward the liquid crystal element, and the analyzer may be the only optical member disposed in the optical path between the liquid crystal element and the observation optical system.

Since the optical path of the light traveling from the light source to the liquid crystal element is bent by the reflective member, it is possible to realize a compact, light apparatus. In the optical path between the liquid crystal element and the observation optical system, the analyzer is disposed as the only optical member, and no other optical member such as a prism is disposed. Thus, no unnecessary reflection whatsoever occurs on a surface inside the prism, and therefore it is possible to present a bright image to the observer.

In the image display apparatus according to the invention, it is preferable that the reflective member have an optical power. This makes it possible to condense the light from the light source with the reflective member and illuminate the liquid crystal element. It is thus possible to present a brighter image to the observer.

In the image display apparatus according to the invention, with respect to the light emerging from the screen center of the liquid crystal element and traveling to the center of the optical pupil, it is preferable that its reflection angle with respect to a reflective electrode be 10 degrees or more but less than 40 degrees.

The rays emerging from the screen center of the liquid crystal element and traveling to the center of the optical pupil will be referred to as the principal rays. Since the reflection angle of the principal rays with respect to a reflective electrode is 10 degrees or more, the liquid crystal element can be arranged with increased flexibility relative to the observation optical system, and thus the apparatus can be built compact. Since the reflection angle of the principal rays with respect to a reflective electrode is less than 40 degrees, the light reflected from the reflective electrode can be directed to the observation optical system without undergoing total reflection on a back surface in the second base member (the interface between the second base member and the air layer). It is thus possible to allow the observer to observe a high-quality image with no lowering in contrast.

The image display apparatus according to the invention may be further provided with a unidirectional diffuser plate for diffusing the light emitted from the light source in the direction perpendicular to the plane of symmetry of the observation optical system to direct it to the liquid crystal element.

When the light emitted from the light source is diffused by the unidirectional diffuser plate, the beam diameter of that light is made larger in the direction perpendicular to the plane of symmetry and smaller in the direction that lies within the plane of symmetry and in which an angle is formed between the inclined surface of the second base member and the reflective surface of the-liquid crystal display device. Thus, even when the inclination of the inclined surface of the second base member is made smaller, at least part of the back surface reflection light in the second base member can be diverted from the optical path leading to the optical pupil (ghost light can be reduced surely). Thus, it is possible to make the second base member thin and thereby make the apparatus light. Moreover, since the beam diameter is larger in the direction in which the unidirectional diffuser plate diffuses light (in the direction perpendicular to the plane of symmetry), the optical pupil is larger in this direction, permitting easy observation of an image.

In the image display apparatus according to the invention, the light source may be composed of a plurality of light-emitting diodes (LEDs) for emitting light of different wavelengths, and the plurality of light-emitting diodes may be arranged substantially along the diffusion direction of the unidirectional diffuser plate. With this construction, the light emitted from the individual LEDs can be diffused in the diffusion direction of the unidirectional diffuser plate to present the observer with a satisfactory color image with no color unevenness.

In the image display apparatus according to the invention, the observation optical system includes a volume-phase reflective hologram optical element, and this hologram optical element may be a combiner that directs image light from the liquid crystal display device and light from the outside world simultaneously to the observer's pupil.

This permits the observer to observe the image displayed on the liquid crystal display device and an outside world image simultaneously via the hologram optical element. Moreover, since a volume-phase reflective hologram optical element has narrow diffraction-efficiency half-value wavelength widths, it has high transmittance to external light and permits observation of a bright outside world image; in addition, it permits observation of a bright image with high color purity and viewability even in a form superimposed on the outside world image. Moreover, since the inclined surface of the second base member reduces ghosts by making the emergence angles of the back surface reflection light and the regular image light different, the angle selectivity of the reflective hologram further reduces ghosts.

The image display apparatus according to the invention may be further provided with a unidirectional diffuser plate for diffusing the light emitted from the light source in the direction perpendicular to the plane of symmetry of the observation optical system to direct it to the liquid crystal element, with the diffusion direction of the unidirectional diffuser plate aligned with the direction perpendicular to the optical axis incidence surface of the hologram optical element. The optical axis incidence surface of the hologram optical element denotes the plane including the optical axes of both the light incident on and the light emergent from the hologram optical element.

With this configuration, when the light emitted from the light source is diffused by the unidirectional diffuser plate, the beam diameter of that light is made larger in the direction perpendicular to the plane of symmetry (the optical axis incidence surface) and smaller in the direction that lies within the plane of symmetry and in which an angle is formed between the inclined surface of the second base member and the reflective surface of the liquid crystal display device. Thus, even when the inclination of the inclined surface of the second base member is made smaller, at least part of the back surface reflection light in the second base member can be diverted from the optical path leading to the optical pupil (ghost light can be reduced surely). Thus, it is possible to make the second base member thin and thereby make the apparatus light. Moreover, since the beam diameter is larger in the direction in which the unidirectional diffuser plate diffuses light (in the direction perpendicular to the plane of symmetry), the optical pupil is larger in this direction, permitting easy observation of an image.

Wavelength selectivity is lower (the deviation in diffraction wavelength due to a deviation in incidence angle is smaller), and hence the diffraction efficiency of a hologram is higher, in the direction perpendicular to the optical axis incidence surface than in the direction parallel to the optical axis incidence surface. Accordingly, by aligning the diffusion direction of the unidirectional diffuser plate with the direction perpendicular to the optical axis incidence surface of the hologram optical element, it is possible to form the optical pupil large in the diffusion direction and thereby permit the observer to observe a bright image.

In the image display apparatus according to the invention, the light source may be composed of a plurality of light-emitting diodes for emitting light of different wavelengths, the plurality of light-emitting diodes may be arranged substantially along the direction perpendicular to the optical axis incidence surface of the hologram optical element, and the diffraction-efficiency peak wavelengths of the hologram optical element corresponding to a plurality of wavelengths may substantially coincide with the intensity peak wavelengths of the individual light-emitting diodes.

Since wavelength selectivity is lower in the direction perpendicular to the optical axis incidence surface than in the direction parallel to the optical axis incidence surface, arranging the LEDs substantially along that direction allows the observer to observe a high-quality image with no color unevenness.

Moreover, since the diffraction-efficiency peak wavelengths of the hologram optical element corresponding to a plurality of wavelengths substantially coincide with the intensity peak wavelengths of the individual light-emitting diodes, the light from the LEDs can be diffracted efficiently with the hologram optical element. This allows the observer to observe a brighter image that is viewable even in a form superimposed on an outside world image. Moreover, since the pupils for the plurality of wavelengths coincide in position, it is possible to make the optical pupil smaller as a whole. Thus, even with a small inclination of the inclined surface, it is possible to reduce ghosts, and to make the second base member thin and thereby make the apparatus light.

In the image display apparatus according to the invention, the observation optical system may include a first transparent substrate for, on one hand, totally reflecting the image light from the liquid crystal display device inside itself to direct it to the observer's pupil and for, on the other hand, transmitting external light to direct it to the observer's pupil.

By use of a first transparent substrate as described above, it is possible to allow observation of the image displayed on the liquid crystal display device and simultaneously, since transmittance to external light is high, to observe a bright outside world image in a wide viewing range. It is also possible to make the first transparent substrate thin and thereby make the apparatus light.

In the image display apparatus according to the invention, it is preferable that the observation optical system have a second transparent substrate for canceling refraction of external light at the first transparent substrate. This makes it possible to prevent distortion in the outside world image observed via the observation optical system by the observer. It is also possible to observe, via the observation optical system, a bright outside world image in a wider viewing range.

A head-mounted display according to the invention may include the image display apparatus according to the invention described above and supporting means for supporting the image display apparatus in front of an observer's eye. With this construction, since the image display apparatus is supported by the supporting means, the observer can observe the image presented by the image display apparatus in a hands-free fashion.

As described above, according to the present invention, back surface reflection light reducing means reduces incidence of back surface reflection light on an optical pupil. Thus, even with a construction in which image light emerges in a direction inclined relative to the direction perpendicular to the reflective surface of a liquid crystal display device, it is possible to prevent a lowering in the contrast of the displayed image, and thus the observer can observe an image with satisfactory display quality.

It will be clear from the above description that the invention allows many modifications and variations. It should therefore be understood that the invention can be carried out without being limited by any specific description given herein, within the scope of the appended claims.

What is claimed is:

1. An image display apparatus comprising:
a light source;
a reflective liquid crystal display device for displaying an image by modulating light from the light source; and
an observation optical system having an axis-asymmetric optical power, the observation optical system directing, to an optical pupil, image light emerging in a direction inclined relative to a direction perpendicular to a reflective surface of the liquid crystal display device,
wherein the liquid crystal display device comprises:
a liquid crystal element for modulating the light from the light source;
a polarizer for transmitting, of the light emitted from the light source, light of a predetermined polarization direction so as to direct it to the liquid crystal element; and
an analyzer for transmitting, of light emerging from the liquid crystal element, light of a polarization direction perpendicular to the predetermined polarization direction so as to direct it to the observation optical system, and
wherein the liquid crystal element comprises:
a first base member having a reflective electrode formed thereon so as to correspond to each pixel;
a second base member being transparent;
liquid crystal held between the first and second base members; and
a back surface reflection light reducer for reducing incidence, on the optical pupil, of light incident from an outer, air side via the second base member, then reflected on the reflective electrode, then reflected on a back surface in the second base member, and then emerging via another reflective electrode to the air side.

2. The image display apparatus according to claim 1,
wherein the liquid crystal modulates the incident light by controlling phase of polarization.

3. The image display apparatus according to claim 1,
wherein the back surface reflection light reducer comprises an inclined surface, which is an air-side surface of the second base member inclined relative to the reflective surface of the liquid crystal display device, and
wherein, when an axis optically connecting between a screen center of the liquid crystal element and a center of the optical pupil is taken as an optical axis,
the observation optical system is formed symmetrically about a plane including the optical axis, and
the inclined surface is so inclined as to form an angle relative to the reflective surface within the plane of symmetry.

4. The image display apparatus according to claim 3,
wherein the inclined surface is so inclined that, of light entering the second base member from the reflective electrode, light undergoing back surface reflection in the second base member and then emerging via the other reflective electrode from the second base member has a larger emergence angle than light emerging from the second base member without undergoing back surface reflection in the second base member.

5. The image display apparatus according to claim 3,
wherein the inclined surface is inclined at an inclination angle of 1 degree or more relative to the reflective surface.

6. The image display apparatus according to claim 5,
wherein the inclined surface is inclined at an inclination angle of 10 degrees or less relative to the reflective surface.

7. The image display apparatus according to claim 1, further comprising:
a reflective member for reflecting the light from the light source toward the liquid crystal element,
wherein the analyzer is disposed as an only optical member in an optical path between the liquid crystal element and the observation optical system.

8. The image display apparatus according to claim 7,
wherein the reflective member has an optical power.

9. The image display apparatus according to claim 1,
wherein light emerging from a screen center of the liquid crystal element and traveling toward a center of the optical pupil has a reflection angle of 10 degrees or more but less than 40 degrees with respect to the reflective electrode.

10. The image display apparatus according to claim 3, further comprising:
a unidirectional diffuser plate for diffusing the light emitted from the light source in a direction perpendicular to the plane of symmetry of the observation optical system so as to direct it to the liquid crystal element.

11. The image display apparatus according to claim 10,
wherein the light source comprises a plurality of light-emitting diodes for emitting light of different wavelengths, and
wherein the plurality of light-emitting diodes are arranged substantially along the diffusion direction of the unidirectional diffuser plate.

12. The image display apparatus according to claim 3,
wherein the observation optical system comprises a volume-phase reflective hologram optical element, and
wherein the hologram optical element is a combiner directing image light from the liquid crystal display device and light from an outside world simultaneously to an observer's pupil.

13. The image display apparatus according to claim 12, further comprising:
a unidirectional diffuser plate for diffusing the light emitted from the light source in a direction perpendicular to the plane of symmetry of the observation optical system so as to direct it to the liquid crystal element,
wherein the diffusion direction of the unidirectional diffuser plate coincides with a direction perpendicular to an optical axis incidence surface of the hologram optical element.

14. The image display apparatus according to claim 12,
wherein the light source comprises a plurality of light-emitting diodes for emitting light of different wavelengths,
wherein the plurality of light-emitting diodes are arranged substantially along a direction perpendicular to an optical axis incidence surface of the hologram optical element, and
wherein diffraction-efficiency peak wavelengths of the hologram optical element corresponding to a plurality of wavelengths are substantially equal to intensity peak wavelengths of the light-emitting diodes.

15. The image display apparatus according to claim 1,
wherein the observation optical system comprises a first transparent substrate for totally reflecting the image light from the liquid crystal display device inside itself so as to direct it to an observer's pupil while transmitting external light so as to direct it to the observer's pupil.

16. The image display apparatus according to claim 15,
wherein the observation optical system comprises a second transparent substrate canceling refraction of the external light in the first transparent substrate.

17. A head-mounted display comprising:
the image display apparatus according to claim 1, and
a support mechanism supporting the image display apparatus in front of an observer's eye.
